(19) United States
(12) Patent Application Publication
(10) Pub. No.: US 2018/0259342 A1
(43) Pub. Date: Sep. 13, 2018

(54) SYSTEM AND METHOD FOR DEAD RECKONING FOR A DRONE

(71) Applicant: QUALCOMM Incorporated, San Diego, CA (US)

(72) Inventors: Suresh Kumar Bitra, Mangalagiri (IN); Meghna Agrawal, Cupertino, CA (US); Bala Ramasamy, San Diego, CA (US)

(21) Appl. No.: 15/455,748

(22) Filed: Mar. 10, 2017

(51) Int. Cl. G01C 21/16; B64C 39/02; B64C 27/08; B64D 45/00

(52) U.S. Cl. CPC G01C 21/165; B64C 39/024; B64D 2045/0085; B64D 45/00; B64C 2201/024; B64C 27/08

(57) ABSTRACT

Disclosed is a method and apparatus for performing positioning of an unmanned aerial vehicle (UAV). The method may include determining a first position of the UAV using a first positioning system during flight of the UAV. The method may also include deactivating the first positioning system after determining the first position, and detecting one or more motor characteristics of one or more motors of the UAV during flight. Furthermore, the method may include determining a second position of the UAV based on the first position and one or more motions of the UAV that correspond to the detected one or more motor characteristics.

### FIELD

The subject matter disclosed herein relates generally to positioning processes performed by unmanned aerial vehicles, such as drone aircrafts.

### BACKGROUND

The proliferation of unmanned aerial vehicles (UAVs), or drones, continues to expand with their increasing popularity, increasing ease of use, and decreasing cost of owning/operating UAVs. Modern technologies, such as global navigation satellite system (GNSS) positioning, enable the tracking of UAVs during flight, as well as guided and/or autonomous navigation based on pre-programmed routes. For example, UAVs often employ GNSS positioning systems, such as global positioning systems (GPS), to provide routing and navigation support during flight of the UAVs.

Despite the benefits that GNSS positioning systems provide to UAVs, GNSS positioning systems consume a large amount of power during use. Because weight and form factor are major concerns for the design of UAVs, a UAV's power source is often limited (e.g., by a maximum battery size, capacity, and weight). The power usage of GNSS positioning systems in UAVs is therefore a great limitation to the use of UAVs in terms of flight time and/or flight range.

### BRIEF DESCRIPTION OF THE DRAWINGS

FIG. 1 is a block diagram of an exemplary system architecture for performing dead reckoning based on motor characteristics of a unmanned aerial vehicle (UAV);

FIG. 2 is block diagram of one embodiment of a UAV;

FIG. 3 is a flow diagram of one embodiment of a method for performing motor characteristic based dead reckoning in a UAV during flight; and

FIG. 4 is a flow diagram of one embodiment of a method for generating motion estimation parameters for motor characteristic based dead reckoning.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

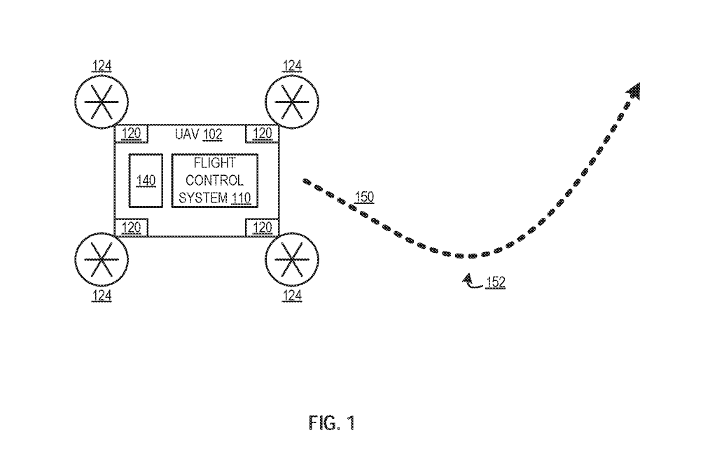

FIG. 1 is a block diagram of an exemplary system architecture for performing dead reckoning based on motor characteristics of an unmanned aerial vehicle (UAV). In embodiments discussed herein, the motor characteristic based dead reckoning is utilized to extend the flight time of a UAV by optimizing power consumption during UAV positioning. As discussed herein, the terms UAV and drone are used interchangeably for an aircraft without an onboard human pilot, and which is capable of being remotely or autonomously controlled.

In one embodiment, the motion of UAV 102 is controlled by a flight control system 110, which is responsible for controlling the motors 120 and therefore the motion 150 of a UAV 102. UAV's 102 flight control system 110 is also responsible for other flight related tasks, such as performing stabilization, autopilot, etc. For example, UAV 102 is illustrated with four motors 120 powering four rotors 124, and represents a quad copter drone. However, other numbers of motors and rotors could be used consistent with the discussion herein.

Flight controller 102, in embodiments, is a processing system of UAV 102, that can adjust altitude, pitch, speed, yaw, direction, etc. of UAV 102 based on power/voltage applied to each motor 120. In embodiments, altitude, pitch, speed, etc. can be adjusted by flight controller 102 in other ways, for example, by controlling motor servomechanisms of each motor 120 to rotate a specific number of times, by counting individual and/or total rotations of each motor 120, etc. In embodiments, flight control system 110 also utilizes one or more sensors or components 140, such as a GNSS system, accelerometers, gyroscopes, wind speed sensors, barometric sensors, etc. when determining a position of UAV 102 during flight, as well as for other tasks performed by flight control system 110. However, because constant usage of GNSS and other sensors can be a significant power drain, in embodiments, flight control system 110 performs positioning for extended periods of time without GNSS, accelerometers, gyroscopes, wind speed sensors, etc.

In one embodiment, power consumption of UAV 102 can be significantly reduced by utilizing dead reckoning based, at least in part, on motor characteristics. In contrast to dead reckoning that utilizes a measured speed of a vehicle and direction of travel, embodiments of motor characteristic based dead reckoning performed by flight control system 110 utilizes a last known position, such as that provided by a GNSS system, as well as one or more motor characteristics to determine a position of the UAV during flight. The motor characteristics enable the flight control system 110 to model motions during UAV's 102 flight (e.g., speed, direction, altitude, etc.) for estimating an expected motion of the UAV 102 based on motor characteristics detected by flight control system 110. That is, motor speed, power applied to motors, rotational speed of rotors, servomechanism rotation, counted motor rotations, other motor sensors, relationships of characteristics of each motor relative to one another, etc. are associated with flight characteristics that model/determine motions of the UAV 102, such as expected altitude, change in altitude, yaw direction, yaw speed, direction of lateral movement, speed of lateral movement, etc. Furthermore, these motor characteristics are relative to characteristics of each UAV (e.g., UAV weight, motor size, motor type, aerodynamics, etc. of a specific UAV). For example, the motor characteristics may indicate that when flight control system 110 applies power to increase the speed, number of rotations, torque, etc. of all motors 120, UAV 102 will increase altitude at a certain rate and/or acceleration. As another example, the motor characteristics may indicate that when flight control system 110 applies power to a certain subset of motors than that applied to a different subset of motors, the UAV 102 will have a certain speed of lateral movement. As yet another example, the motor characteristics may indicate that when flight control system 110 applies power to opposing motors, the UAV 102 will rotate at a certain speed.

In embodiments, flight control system 110 utilizes the motor characteristics to model the movement 150 of the UAV. More specifically, from a last known position of UAV 102, the motor characteristics are associated with movements of the UAV, and enable flight control system 110 to perform positioning based on the detected motor characteristic and their associated UAV movements. As discussed herein, this technique is referred to as motor characteristic based dead reckoning. The motor characteristic based dead reckoning performed by flight control system 110 is able to determine UAV's 102 current position, velocity, direction of movement, changes in direction 152, etc. based on motor characteristics. Therefore, the motor characteristic based dead reckoning can be utilized for longer periods of time, thus enabling the flight control system to perform positioning based operations (e.g., navigation, rout changes, position tracking, etc.) without the need to activate a GNSS based positioning system, thereby extending flight times and flight range of UAV 102. Furthermore, motor characteristic based dead reckoning may further be used in addition to one or more other dead reckoning based techniques (e.g., accelerometer, gyroscope, or other motion sensor based dead reckoning) to enhance the result of the other technique, constrain the results of the other technique, etc. For example, position uncertainty that is the result of motor characteristic based dead reckoning and the constant movement of UAV 102 over a period of time, can be compared with one or more threshold values associated with overall positioning uncertainty, positioning uncertainty error accumulated by another technique, etc.. Motor characteristic based dead reckoning, in embodiments, may then be used to determine whether this position uncertainty growth is feasible or unwarranted. Furthermore, motor characteristic based dead reckoning may also reduce the need and/or frequency of signal filtering for a motion sensor based technique, may reduce maintenance of the UAV 102 (e.g. maintenance to ensure motor noise and movement are not influencing the motion sensor based dead reckoning results), may reduce design/construction time for UAV 102 (e.g., design and construction parameters need not be concerned about influencing the accelerometer/gyroscope dead reckoning results).

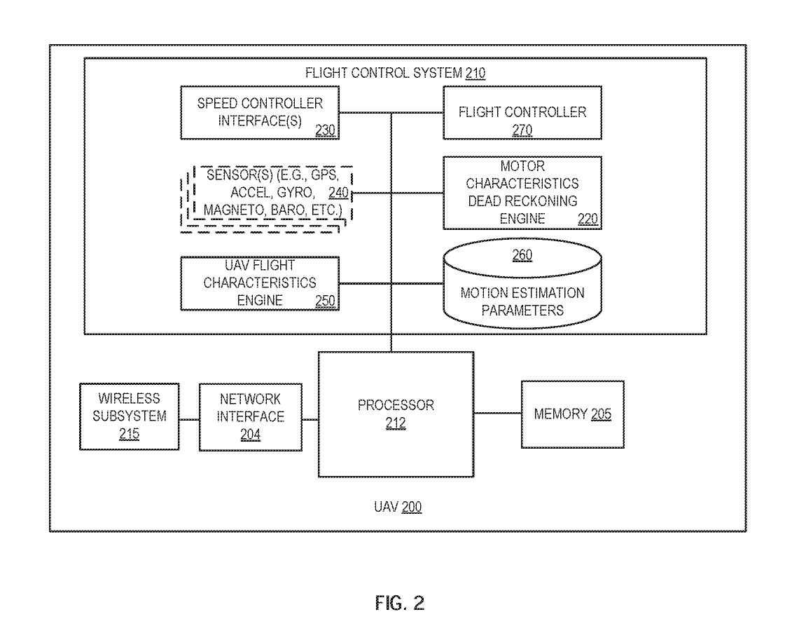

FIG. 2 is block diagram of one embodiment of a UAV. UAV 200 provides additional details for UAV 102 discussed above in FIG. 1. Furthermore, as discussed above, UAV 200 may be a drone aircraft.

In one embodiment, UAV 200 is a system, which may include one or more processors 212, a memory 205, a network interface 204, and a wireless subsystem 215. It should be appreciated that UAV 200 may also include, although not illustrated, a user and/or hardware interface, a power device (e.g., a battery), motors and rotors (e.g. motors 120 and rotors 124 illustrated in FIG. 1), as well as other components typically associated with UAVs/drones. Although only a single wireless subsystem 215 is illustrated, it is understood that network interface 204 may also be capable of communicatively coupling UAV 200 to a number of wireless subsystems 215 (e.g., Bluetooth, WiFi, Cellular, or other networks) to transmit and receive data streams through a wireless link to/from a network. In one embodiment, wireless subsystem 215 may also be used by UAV 200 to receive one or more GNSS (e.g. GPS, GLONASS, BeiDou, etc.) positioning signals.

Memory 205 may be coupled to processor 212 to store instructions for execution by processor 212. In some embodiments, memory 205 is non-transitory. Memory 205 may also store one or more processing modules of flight control system 210, such as speed controller interfaces 230, flight controller 270, sensor and/or motor dad reckoning engine 220, UAV flight characteristics engine 250, an interface to one or more sensors 240, and a plurality of motion estimation parameters 260, to implement embodiments described herein. It should be appreciated that embodiments of the invention as will be hereinafter described may be implemented through the execution of instructions, for example as stored in the memory 205 or other element, by processor 212 of UAV 200 and/or other circuitry of UAV 200 and/or other devices. Particularly, circuitry of UAV 200, including but not limited to processor 212, may operate under the control of a program, routine, or the execution of instructions to execute methods or processes in accordance with embodiments of the invention. For example, such a program may be implemented in firmware or software (e.g. stored in memory 205 and/or other locations) and may be implemented by processors, such as processor 212, and/or other circuitry of UAV 200. Further, it should be appreciated that the terms processor, microprocessor, circuitry, controller, etc., may refer to any type of logic or circuitry capable of executing logic, commands, instructions, software, firmware, functionality and the like.

Further, it should be appreciated that some or all of the functions, engines or modules described herein may be performed by UAV 200 itself and/or some or all of the functions, engines or modules described herein may be performed by another system connected through network interface 204 to UAV 200. Thus, some and/or all of the functions may be performed by another system and the results or intermediate calculations may be transferred back to UAV 200. In some embodiments, such other device may comprise a server (not shown). In some embodiments, the other device is configured to generate motion estimations, perform dead reckoning, performing positioning processes, etc., for example, based on a known configuration of the UAV 200.

Flight control system 210 is responsible for controlling flight of UAV 200. In one embodiment, flight control system 210 may also be programmed, such as by specifying a destination, to enable flight control system 210 to autonomously navigate UAV 200 to the specified destination. However, in other embodiments, flight control system 210 may also be operated remotely by a human operator providing manual commands to fly UAV 200 to a destination. In either scenario, flight controller 270 issues commands to speed controller interfaces 230 for execution of one or more flight operations. For example, flight controller 270 can control the speed, power, torque, etc. applied to each motor of UAV 200 to, for example, cause the UAV to change/maintain altitude, alter direction of travel, change/maintain speed of flight, etc.

In one embodiment, during autonomous flight, such as flight of UAV 200 along a route from an initial location to a destination location, flight controller 270 utilizes motor characteristic based dead reckoning to estimate a location of UAV along the route. In one embodiment, flight controller 270 first obtains a known position of UAV 200 from sensors 240, such as obtaining a GNSS based position. Flight controller, 270 then provides the known position to motor characteristics dead reckoning engine 270.

In one embodiment, motor characteristics dead reckoning engine 270 is responsible for estimating positions of the UAV 200 during flight based on a known position, and one or more motor characteristics of the UAV observed and/or measured over a period of time. The one or more motor characteristics, such as individual and relative motor speeds, power applied to the motors, a rate of rotation applied to each motor, a count of rotations of each motor, torque applied to the motors, rotor speed inferred from one or more motor characteristics, etc., are obtained by motor characteristics dead reckoning engine 270 by querying the flight controller 270 and obtaining the characteristics from one or more relevant sensor.

Based on the obtained motor characteristics, motor characteristics dead reckoning engine 270 then determines a relationship between the obtained motor characteristics and a motion of the UAV 200. The relationship, in embodiments discussed herein, models the motion (e.g., speed, direction, altitude, yaw, etc.) of the UAV 200 based on detected sets of motor characteristics. In one embodiment, the relationship between the motor characteristics and the expected UAV motion can be modeled by UAV flight characteristics engine 250 based on flight of the UAV and position tracking of the UAV using a GNSS system. In one embodiment, UAV flight characteristics engine 250 performs a machine learning process, such as neural network based machine learning, support vector machine learning, decision tree based learning, etc. to model the flight characteristics based on individual and relative motor characteristics of UAV 200. For example, during indoor and outdoor flights that include altitude changes, changes in flight direction, carrying loads of different weights, etc., a comprehensive model of the relationship between the motor characteristics and the UAV's corresponding motions can be developed prior to flight of the UAV, and stored in motion estimation parameters data store 260. In embodiments, the trained machine learning model and/or the parameters for estimating UAV motion may be stored in motion estimation parameters data store 260.

In one embodiment, based on the known position of UAV 200, and the relationship, association, correspondence, etc. between motor characteristics and expected motions of the UAV 200, motor characteristics dead reckoning engine 220 determines a location of the UAV. For example, based on an initial position (Xᵢ, Yᵢ, Zᵢ) and one or more detected motor characteristic based motions (m), motor characteristics dead reckoning engine 220 determines the new position of UAV as a function of the passage of time (T). For example, based on motor characteristics associated with motions of the UAV 200, motor characteristics dead reckoning engine 220 can determine for a period of time a distance that UAV 200 traveled, whether the UAV 200 changed altitude, when the UAV 200 changes direction, as well as other positioning related determinations.

In embodiments, parameters of the motor characteristics can be tuned in real time by UAV flight characteristics engine 250 based on data captured by one or more sensors 240 during flight (e.g., GNSS system data, accelerometer data, barometric pressure changes, and/or other sensor data). For example, flight controller 270 may be applying certain motor commands, and based on the motion estimation parameters 260 for modeling of motor characteristics to expected flight/motions of the UAV, the flight controller 270 would expect a certain lateral movement, altitude, etc. However, due to headwinds, the weight of a load, motor failure, etc., one or more parameters 260 associated with motor characteristics can be adjusted by UAV flight characteristics engine 250, such as multiplying lateral movement motor characteristics by a factor to account for a headwind. As another example, real-time motor characteristics and the associated motion of UAV 200 may be analyzed by a machine learning model generated determination of UAV 200 motions. The real-time motor characteristics and associated motions may then refine an existing machine learning model based on the actual/real-time flight of the UAV 200. The updated and real-time tuned motion estimation parameters 260 may then be used by motor characteristics dead reckoning engine 220 when performing motor characteristic based dead reckoning to obtain a more accurate determination of location of UAV 200.

In embodiments, the relationship between motor characteristic based motion estimation parameters and expected UAV motions, whether predetermined and/or tuned in real time, may be associated with a positioning error. For example, for each N minutes of flight time, a position error of X meters is expected when estimating lateral movement, a position error of Y meters is expected when estimating vertical movement, a position error of Z meters is expected during estimation of movement during UAV acceleration, etc. As another example, based on non-GNSS sensor data 240 periodically measured by the flight control system 210, a position error of M meters is determined. It should be noted that the position determination error can be determined not only in terms of distance, but in any form of measurement, (e.g., passage of time, a custom scale, etc.). In embodiments, motion estimation parameters 260, or subsets of the motion estimation parameters 260, are associated with a positioning error value such that an accumulated positioning error for the motion estimation parameter can be determined for a determined position estimate. Motor characteristics dead reckoning engine 220 determines one or more accumulated positioning errors over a period of time. When the accumulated position error reaches a threshold error, based either on passage of a certain length of time, accumulated positioning error beyond a threshold distance, etc., motor characteristics dead reckoning engine 220 periodically activates a GNSS based positioning process to obtain a new known position of the UAV 200. That is, the periodically obtained GNSS based position provides the flight controller 270 and/or motor characteristics dead reckoning engine 220 with a trusted position of UAV 200 from which further motor characteristic based dead reckoning can be performed, and the GNSS system deactivated.

In embodiments, the activation of a GNSS system and/or other sensors of the UAV 200 to correct for positioning error may additionally, or alternatively, be based on other factors besides accumulated error and passage of time. In embodiments, waypoint characteristics of a flight plan of UAV 200 may be used by the flight controller 270 and/or dead reckoning engine 220 to periodically activate UAV's 200 positioning systems (e.g., GNSS system) even when an accumulated error is below a threshold error. For example, when UAV is flying along a route that includes a turn (e.g., a waypoint having a specified characteristic), flight controller 270 and/or dead reckoning engine 220 may activate GNSS based positioning to ensure that the resulting heading, position, etc. are correct after the turn. In embodiments, the flight controller 270 and/or dead reckoning engine 220 may additionally or alternatively activate a gyroscope without activating the GNSS system to ensure the heading is correctly changed after a turn, and wake the GNSS system based on accumulated error. Therefore, flight controller 270 and/or dead reckoning engine 220 may determine to activate certain sensors 240 based on the characteristics of the waypoint.

In another embodiment, route characteristics of the flight plan of UAV 200 can also be used by flight controller 270 and/or dead reckoning engine 220 to activate GNSS, sensor, or other positioning processes. The route characteristics can include the characteristics of the area surrounding the UAV during flight, such as flight through a city, flight through a rural area, flight through an unpopulated area, etc. The frequency/duration with which a GNSS system or other UAV sensors are activated can be based on such flight plan route characteristics by adjusting the error threshold based on the route characteristic(s). For example, during flight through an unpopulated area, the frequency/duration of GNSS system use can be adjusted, for example, by raising an accumulation error threshold from an initial level to a higher level (e.g., 0.5, 1, 2, 5, etc. kilometers) to account for sparse population, sparse development, no/limited buildings, etc. Conversely, an accumulated positioning error threshold in a city may be lowered (e.g., limited to 0, 1, 2, etc. meters) due to increased population, dense buildings, and other factors related to personal and/or property based safety concerns.

In one embodiment, certain conditions unrelated to waypoint and route characteristics, may be utilized by flight controller 270 and/or dead reckoning engine 220 to activate GNSS based positioning and deactivate motor characteristic based dead reckoning. For example, UAV 200 may include a Bluetooth, WiFi, camera, etc. based collision avoidance system (not shown). When flight controller 270 and/or dead reckoning engine 220 detects a potential collision scenario using the Bluetooth, WiFi, camera, etc. based collision avoidance system, the Bluetooth, WiFi, camera, etc. may activate the GNSS based positioning system until the collision scenario ends.

As discussed herein, continuous GNSS based positioning and sensor usage by a UAV may be avoided with embodiments of the motor characteristic based dead reckoning performed by flight control system 210. Beneficially, power consumption can be reduced by applying the motor characteristic based dead reckoning for extended periods of flight time of the UAV. Furthermore, accuracy of the estimated position during periods of motor characteristic based dead reckoning can be increased based on the real-time tuning of the motor characteristics, as well as the conditional activation of GNSS system and/or UAV sensors.

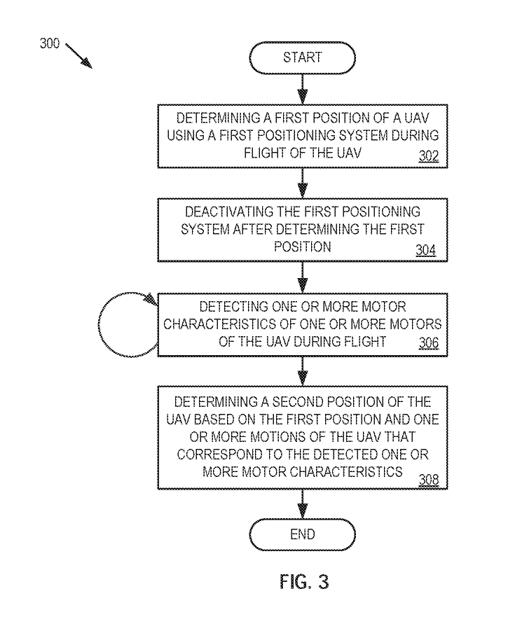

FIG. 3 is a flow diagram of one embodiment of a method 300 for performing motor characteristic based dead reckoning in a UAV during flight. The method 300 is performed by processing logic that may comprise hardware (circuitry, dedicated logic, etc.), software (such as is run on a general purpose computer system or a dedicated machine), firmware, or a combination. In one embodiment, the method 300 is performed by a UAV's flight control system (e.g., flight control system 110 of UAV 102 or flight control system 210 of UAV 200).

Referring to FIG. 3, processing logic begins by determining a first position of a UAV using a first positioning system during flight of the UAV (processing block 302). As discussed herein, the UAV may be a drone aircraft that includes a plurality of motors for turning a plurality of rotors of the UAV to enable the UAV to fly. Furthermore, based on navigation processes performed by the UAV, the UAV is capable of autonomous and/or user controlled flight to a destination along a route (e.g., a flight plan composed of intermediate destinations referred to as waypoints). Furthermore, the UAV/drone can include one or more positioning systems, such as GNSS systems, capable of determining an accurate and real-time position of the UAV. However, as discussed above, such GNSS based positioning systems may consume an inordinate amount of the limited power available to the UAV, thereby limiting flight time and/or flight range of the UAV. Processing logic therefore deactivates the first positioning system after the first position is determined (processing block 304).

Processing logic then detects one or more motor characteristics of one or more motors of the UAV during flight (processing block 306). The motor characteristics can include a plurality of different characteristics, such as direct motor characteristics (e.g., type of motor, manufacturer motor specifications, torque ratings, power ratings, etc.), measured motor characteristics (e.g., power/voltage being supplied to a motor, speed of rotation of a motor drive shaft, a count of a number of motor rotations, etc.), indirect motor characteristics (e.g., inferred rotor rotation based on drive shaft speed, lift supplied by a rotor based on drive shaft speed, etc.), as well as other motor characteristics. Furthermore, the characteristics may be determined for each individual motor so that relative characteristics of the motors and/or sets of motors can be determined. In embodiments, the motor characteristics are determined periodically during the motor characteristic based dead reckoning process.

Processing logic determines a second position of the UAV based on the first position and one or more motions of the UAV that correspond to the detected one or more motor characteristics (processing block 308). As discussed herein, the motor characteristics of the individual UAV motors as well as the relative motor characteristics correspond to, are associated with, have a relationship with, etc. how a UAV moves during flight. For example, when all UAV motors apply the same amount of power over a certain level, the UAV will gain altitude at a certain rate. As another example, when a subset of proximate motors applies more power than another subset of proximate motors, the UAV may move horizontally at a certain rate. As another example, certain opposing motors may cause the UAV to yaw at a certain rate. Other movements and associated motors characteristics may be associated with one another and/or used in a machine learning process to model any movement of the UAV based on one or more motor characteristics. Based on the detected motor characteristics, the associated motion(s) of a UAV are used by processing logic to determine new positions of the UAV from previous positions.

In embodiments, processing logic may also determine whether a new position should be obtained using the first positioning system. As discussed above, there are several scenarios in which it is desirable to determine a new position using, for example, GNSS. For example, based on a passage of a certain amount of time for which motor characteristic based dead reckoning is used, based on an accumulated positioning error, based on characteristics of a waypoint in a flight plan where positioning error may be introduced (e.g., turns, elevation changes), based on characteristics of areas of a flight plan (e.g., flight through a cityscape or populated area), based on detected flight characteristics (e.g., unexpected accelerations), as well as other conditions that could add error to the motor characteristic based dead reckoning positioning process of processing block 308. In one embodiment, when these conditions are not satisfied (e.g., accumulated error remains below a threshold, waypoint and route characteristics satisfactory, etc.), the process of processing block 306 continue the dead reckoning process of detecting motor characteristics and determining UAV positions based upon those motor characteristics' relationships with UAV motions. However, when one or more of these conditions is satisfied, the process can return to processing block 302 to determine another known position of the UAV before returning to motor characteristic based dead reckoning. Furthermore, in embodiments, processing logic will continue to obtain the known positions until the monitored condition passes (e.g., the UAV leaves a city scape).

The process ends when the UAV reaches its destination and/or navigation is no longer needed.

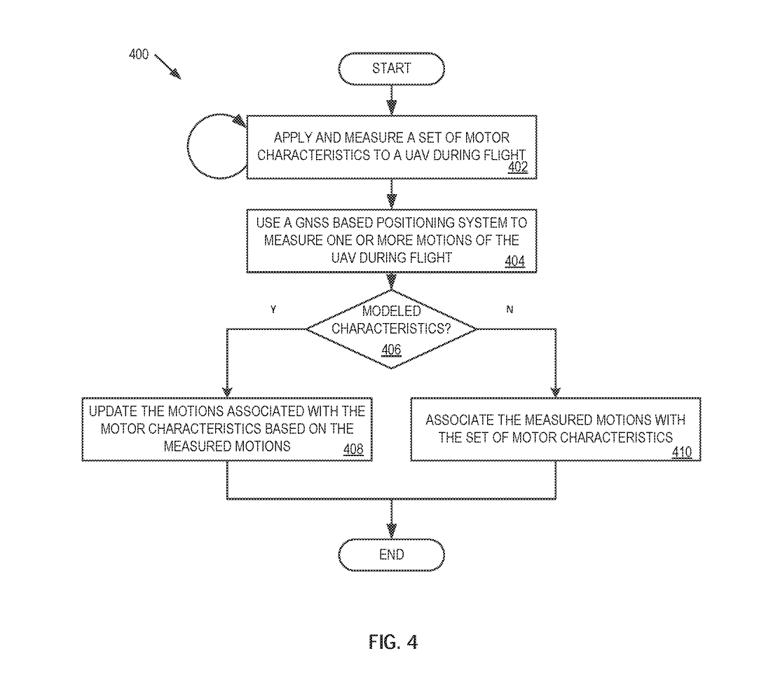

FIG. 4 is a flow diagram of one embodiment of a method for generating motion estimation parameters for motor characteristic based dead reckoning. The method 400 is performed by processing logic that may comprise hardware (circuitry, dedicated logic, etc.), software (such as is run on a general purpose computer system or a dedicated machine), firmware, or a combination. In one embodiment, the method 400 is performed by a UAV's flight control system (e.g., flight control system 110 of UAV 102 or flight control system 210 of UAV 200).

Referring to FIG. 4, processing logic begins by applying and measuring a set of motor characteristics to a UAV during flight (processing block 402). Processing logic may apply and/or measure the motor characteristics in order to generate the associations between motor characteristics and UAV motions (e.g., as a part of a modeling process), as well as to refine existing associations (e.g., as part of a real-time and real-world-conditions tuning process). For example, a certain amount of power may be applied to specific UAV motors, a rotation speed of a drive shaft of each motor may be measured, an associated rotor speed may be determined for each motor, etc.

Processing logic then uses a GNSS based positioning system to measure one or more motions of the UAV during flight (processing block 404). The motions can be any motions of the UAV during flight, such as vertical speed, vertical acceleration rate, horizontal speed, horizontal acceleration rate, yaw speed, yaw acceleration rate, etc. Furthermore, these different movements may be measured in controlled conditions, such as indoors, uncontrolled conditions, such as outdoors, or during flight along a preconfigured route.

Processing logic determines whether the applied and/or measured characteristics are associated with modeled characteristics (processing block 406). That is, processing logic determines whether a certain set of measured motion characteristics are associate with UAV motions. When the motor characteristics have already been modeled (e.g., already associated with UAV motions), processing logic utilizes the measured motions to update the motions associated with the applied and/or measured motor characteristics (processing block 408). In embodiments, the updates may be for real-world conditions experienced by a UAV during flight, such as headwinds, tailwinds, rain, snow, weight of a load being carried, failure or malfunction of a motor, rotor, or other UAV part, as well as any other condition impacting the UAV's flight.

When the characteristics have not been modeled, processing logic associates the measured motions with the set of motor characteristics (processing block 410). In embodiments, the association models the determined motion of the UAV when the motion characteristics are applied and/or measured. Thus, any time the motor characteristics are applied and/or measured for future use, the association can be used to determine the UAV's motion.

As discussed herein, the process of determining the position of the UAV may continue indefinitely, for a set period of time, in response to specific detected events, or until a certain amount of positioning error is accumulated. During the period of time in which the UAV is performing motor characteristic based dead reckoning, the UAV is able to conserve power that would have otherwise been consumed by the first (e.g., GNSS) positioning process. The conserved power is therefore able to extend the flight time and/or flight range of the UAV.

It should be appreciated that the UAV discussed herein may communicate via one or more wireless communication links through a wireless network that are based on or otherwise support any suitable wireless communication technology. For example, the UAV may associate with a network including a wireless network. In some aspects the network may comprise a local area network or a wide area network. Furthermore, the UAV may support or otherwise use one or more of a variety of wireless communication technologies, protocols, or standards such as, for example, CDMA, TDMA, OFDM, OFDMA, WiMAX, and Wi-Fi. The UAV may wirelessly communicate with other UAVs, devices, cell phones, other wired and wireless computers, Internet web-sites, etc.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for performing positioning of an unmanned aerial vehicle (UAV), the method comprising:
determining a first position of the UAV using a first positioning system during flight of the UAV;
deactivating the first positioning system after determining the first position;
detecting one or more motor characteristics of one or more motors of the UAV during flight; and
determining a second position of the UAV based on the first position and one or more motions of the UAV that correspond to the detected one or more motor characteristics.

2. The method of claim 1, further comprising:
tuning a parameter corresponding to the relationship between motor characteristics and motions of the UAV in real time based on one or more characteristics of the UAV detected during flight.

3. The method of claim 1, further comprising:
reactivating the first positioning system based on an accumulated positioning error associated with a subsequent position of the UAV determined based, at least in part, on motor characteristics of the UAV detected during flight.

4. The method of claim 3, wherein the accumulated positioning error being accumulated based on passage of time, distance traveled by the UAV during flight, or a combination thereof.

5. The method of claim 1, further comprising:
reactivating the first positioning system based on a waypoint characteristic associated with a waypoint of a flight plan when reached by the UAV during flight.

6. The method of claim 1, further comprising:
reactivating the first positioning system based on a route characteristic associated with one or more characteristics of an area surrounding a portion of a route of a flight plan when reached by the UAV during flight.

7. The method of claim 1, wherein the motor characteristics comprise motor speed, power applied to a motor, rotational speed of a motor drive shaft, a rotor speed inferred from one or more motor characteristics, or a combination thereof, and wherein the associated motions comprise a horizontal motion, a vertical motion, a horizontal rate of acceleration, a vertical rate of acceleration, a yaw motion, a yaw rate of acceleration, or a combination thereof.

8. The method of claim 1, wherein the motor characteristics comprise relative motor characteristics of a plurality of motors of the UAV.

9. The method of claim 1, wherein the UAV is a drone aircraft.

10. The method of claim 1, wherein the first positioning system is a global navigation satellite system (GNSS) system.

11. An apparatus for performing positioning of an unmanned aerial vehicle (UAV), the apparatus comprising:
a memory; and
a processor communicably coupled with the memory, the processor configured to:
determine a first position of the UAV using a first positioning system during flight of the UAV,
deactivate the first positioning system after determining the first position,
detect one or more motor characteristics of one or more motors of the UAV during flight, and
determine a second position of the UAV based on the first position and one or more motions of the UAV that correspond to the detected one or more motor characteristics.

12. The apparatus of claim 11, further comprising the processor configured to tune a parameter corresponding to the relationship between motor characteristics and motions of the UAV in real time based on one or more characteristics of the UAV detected during flight.

13. The apparatus of claim 11, further comprising the processor configured to reactivate the first positioning system based on an accumulated positioning error associated with a subsequent position of the UAV determined based, at least in part, on motor characteristics of the UAV detected during flight.

14. The apparatus of claim 11, wherein the motor characteristics comprise motor speed, power applied to a motor, rotational speed of a motor drive shaft, a rotor speed inferred from one or more motor characteristics, or a combination thereof, and wherein the associated motions comprise a horizontal motion, a vertical motion, a horizontal rate of acceleration, a vertical rate of acceleration, a yaw motion, a yaw rate of acceleration, or a combination thereof.

15. The apparatus of claim 11, wherein the UAV is a drone aircraft.

16. A non-transitory computer readable storage medium including instructions that, when executed by a processor, cause the processor to perform a method for performing positioning of an unmanned aerial vehicle (UAV), the method comprising:
determining a first position of the UAV using a first positioning system during flight of the UAV;
deactivating the first positioning system after determining the first position;
detecting one or more motor characteristics of one or more motors of the UAV during flight; and
determine a second position of the UAV based on the first position and one or more motions of the UAV that correspond to the detected one or more motor characteristics.

17. The non-transitory computer readable storage medium of claim 16, further comprising:
tuning a parameter corresponding to the relationship between motor characteristics and motions of the UAV in real time based on one or more characteristics of the UAV detected during flight.

18. The non-transitory computer readable storage medium of claim 16, further comprising:
reactivating the first positioning system based on an accumulated positioning error associated with a subsequent position of the UAV determined based, at least in part, on motor characteristics of the UAV detected during flight.

19. The non-transitory computer readable storage medium of claim 16, wherein the motor characteristics comprise motor speed, power applied to a motor, rotational speed of a motor drive shaft, a rotor speed inferred from one or more motor characteristics, or a combination thereof, and wherein the associated motions comprise a horizontal motion, a vertical motion, a horizontal rate of acceleration, a vertical rate of acceleration, a yaw motion, a yaw rate of acceleration, or a combination thereof.

20. The non-transitory computer readable storage medium of claim 16, wherein the UAV is a drone aircraft.
